(19) United States
(12) Patent Application Publication
(10) Pub. No.: US 2004/0145975 A1
(43) Pub. Date: Jul. 29, 2004

(54) Portable electronic instrument, such as a wristwatch, including, in particular, an antenna for receiving and/or transmitting radio-frequency signals

(76) Inventors: David Barras, Schlieren (CH); Jean-Philippe Rebeaud, Cressier (CH); Francois Klopfenstein, Delemont (CH)

Correspondence Address: Robinson & Post, L.L.P., 12900 Preston Road, LB-41, Dallas, TX, 75230, US

(21) Appl. No.: 10/754,084

(22) Filed: Jan. 5, 2004

(30) Foreign Application Priority Data
Jul. 5, 2001 (EP) 01202593.8

(51) Int. Cl. A44C 5/00; G04B 37/00

(52) U.S. Cl. 368/281

(57) ABSTRACT

There is disclosed a portable electronic instrument, such as a wristwatch (1), including a case (2) enclosing an electronic module (6) and a display device (5), a crystal (3) fitted onto the case (2), an electric power supply source (4) housed in the case (2) and powering the electronic module (6) and the display device (5), and an antenna (20) for receiving and/or transmitting radio-frequency signals electrically connected to the electronic module (6).

The case (2) includes an exterior body (4) including a bottom (4a) and lateral walls (4b) and a bezel element (7) fitted onto the exterior body (4) and supporting the crystal (3).

The antenna (20) rests on an outer face (7a) of the bezel element (7).

The present invention generally concerns a portable electronic instrument including, in particular, an antenna for receiving and/or transmitting radio-frequency signals. The present invention concerns more particularly a portable electronic instrument, preferably intended to be worn on a user's wrist, such as a wristwatch, including an antenna for the reception of satellite navigation and positioning signals or GPS signals.

Various portable electronic instruments including antennae for receiving and/or transmitting radio-frequency signals have already been proposed. One of these solutions consists, for example, in winding a dipole antenna, formed for example of a printed path on a flexible dielectric substrate, inside a case. Because of the specific arrangement of the antenna, this solution is however unsuitable for making an instrument for receiving GPS signals. This solution is also unsuitable if one wishes to make an instrument having a case made of metallic material, the case disturbing significantly the transmitting and receiving features of the antenna.

Other solutions, consisting in placing an antenna under or on the dial of a watch, are also known. Like the preceding solution, this solution is generally unsuitable for making an instrument having a case made of metallic material.

Patent document No. EP 0 982 639 discloses an electronic instrument intended to be worn on a user's wrist, the instrument being fitted with a patch type antenna allowing, in particular, GPS signals to be received. Various variants are presented in this document, the patch antenna being placed, in each of these variants, in direct proximity to the display device. Although this solution is relatively compact, it nonetheless has numerous drawbacks.

One of these drawbacks lies in the proximity of the antenna and the electronic components of the instrument, such proximity requiring a relatively complicated shielding to be made in order to reduce or avoid mutual disturbance between the antenna and the electronic components of the instrument, in particular the display device and the electronic module of the instrument. This shielding considerably complicates the assembling operations of the various elements and components of the electronic instrument.

Another drawback of this solution, similar to the drawbacks already listed as regards the preceding solutions, lies in the fact that the instrument's exterior parts are necessarily made of a material which does not disturb the functioning of the antenna, in particular a non-metallic material. The aesthetic appearance of the instrument is also dependent on the limited choice of materials able to be used to make the exterior parts of the instrument.

Yet another drawback of these solutions lies in the general aesthetic appearance of the electronic instrument. Further, although relatively compact, the various antenna arrangements envisaged lead to an instrument having prominent parts, which are bothersome and uncomfortable when the instrument is worn on a user's wrist.

A main object of the present invention is to propose a portable electronic instrument including an antenna for receiving and/or transmitting radio-frequency signals, the construction of which enables metallic materials to be used for making the exterior parts of the instrument.

Another object of the present invention is to propose such a solution that provides robust support for the antenna while facilitating the assembling of the various components of the instrument.

Yet another object of the present invention is to propose a solution that is more elegant from the aesthetical point of view and more comfortable to wear than the solutions of the prior art, in particular the solution disclosed in the aforementioned Patent Application No. EP 0 982 639.

A particular object of the present invention is also to facilitate the electric connection of the antenna to the electronic module of the portable instrument.

The present invention thus concerns a portable electronic object, such as a wristwatch, whose features are listed in the independent claim 1.

Advantageous embodiments of the present invention form the subject of the dependent claims.

According to the invention, the case enclosing the electronic module, the display device and the electric power supply source advantageously includes a exterior body including a bottom or back cover and lateral walls, and an element forming the bezel fitted onto the exterior body and carrying the crystal. The bezel element carries, on an outer face of the element, the antenna for receiving and/or transmitting radio-frequency signals.

Consequently, the antenna rests on the case with great robustness and is as far away as possible from the electronic components located inside the instrument case. According to the invention, the electric connection of the antenna to the electronic module is not, however, made more complex. This solution allows, in particular, manufacture of an instrument having a case made of metallic material, the antenna being arranged entirely outside the case.

The assembling of the instrument is further facilitated because the antenna can be arranged beforehand on the bezel element, this element being arranged, only lastly, in the exterior body.

Another advantage of the present invention in particular with respect to the instrument disclosed in Patent Application No. EP 0 982 639 lies in the fact that the case really acts as a mechanical support and does not have solely an aesthetical role. In particular, the invention is inspired by proven horological construction techniques assuring that the assembly is very robust.

Further, with respect to the solutions disclosed in the aforementioned Patent Application No. EP 0 982 639, the electronic instrument according to the invention exhibits greater compactness, increasing comfort for the user's wrist.

According to a particular embodiment of the invention, the instrument further includes an element forming a casing ring, arranged between the bezel element and the back cover, the electronic module and the display device being arranged between the bezel element and the casing ring element. A complete sub-assembly enclosing, in particular, the electronic module and the display device can thus easily be made beforehand and then mounted lastly on the back cover of the exterior body. Preferably, the bezel element and the casing ring element are secured to each other, for example by welding or bonding.

According to a preferred embodiment of the invention, the antenna is an antenna allowing reception of satellite navigation and positioning signals. This antenna is preferably a patch type antenna including a radiating element separated from a ground plane by a dielectric and electrically connected to the electronic module by a feed or excitation conductor, the ground plane of the antenna resting on the outer face of the bezel element and being electrically connected to the electronic module by a ground conductor. The ground plane can advantageously be formed of a stamped metal plate including a least one leg bent out of the ground plane and directly connecting the latter to the electronic module, the leg forming the ground conductor of the antenna.

According to this preferred embodiment of the invention, assembling and connecting the antenna is greatly facilitated, although it is relatively far away from the electronic module. According to this embodiment, it is not necessary to provide the instrument with a pair of distinct conductors, such as a coaxial conductor, to allow feeding or excitation of the antenna, the ground conductor advantageously forming an integral part of the antenna's ground plane. Further, the arrangement of the antenna is such that the various electronic and electric components of the instrument are located substantially behind the antenna's ground plane, this proving an advantage for the purpose of reducing interference with the antenna.

Other features and advantages of the present invention will appear more clearly upon reading the following detailed description of a preferred embodiment of the invention, given solely by way of non-limiting example and illustrated by the annexed drawings, in which:

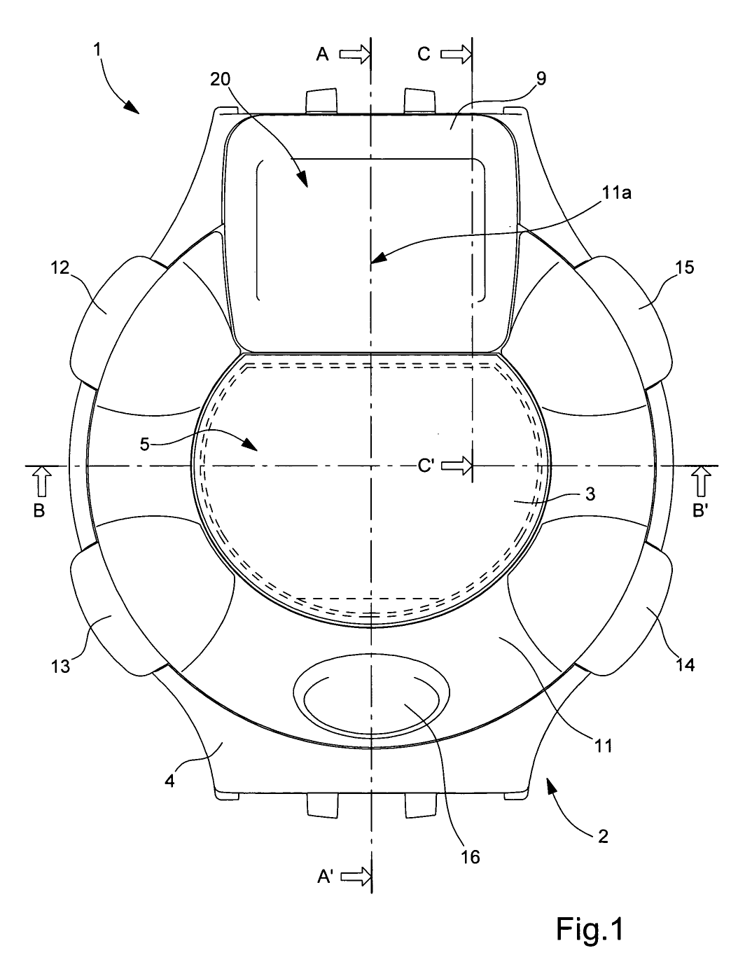

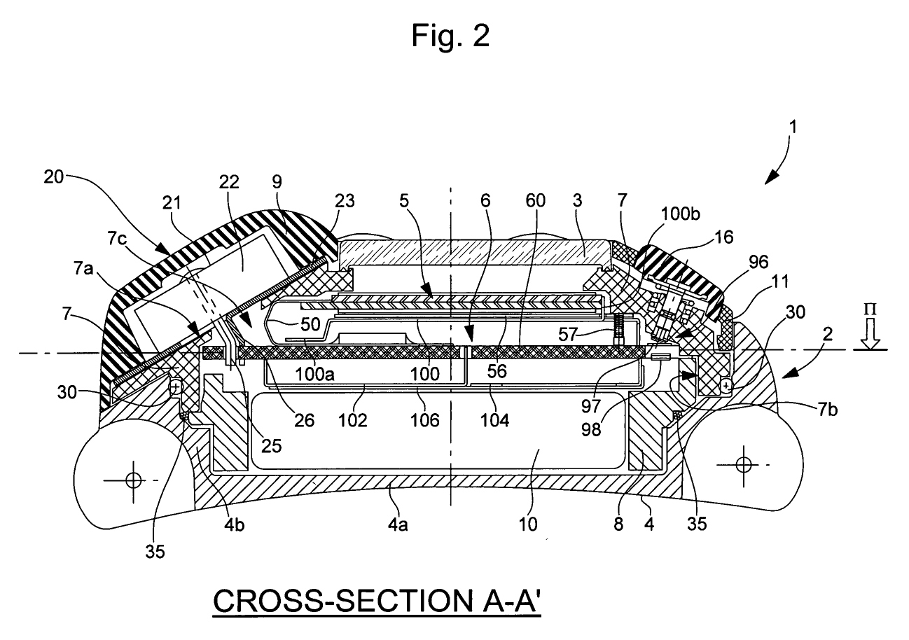

FIG. 1 is a plan view of a wristwatch forming a preferred embodiment of the invention;

FIG. 2 is a cross-section of the wristwatch taken along the cross-section line A-A′ of FIG. 1;

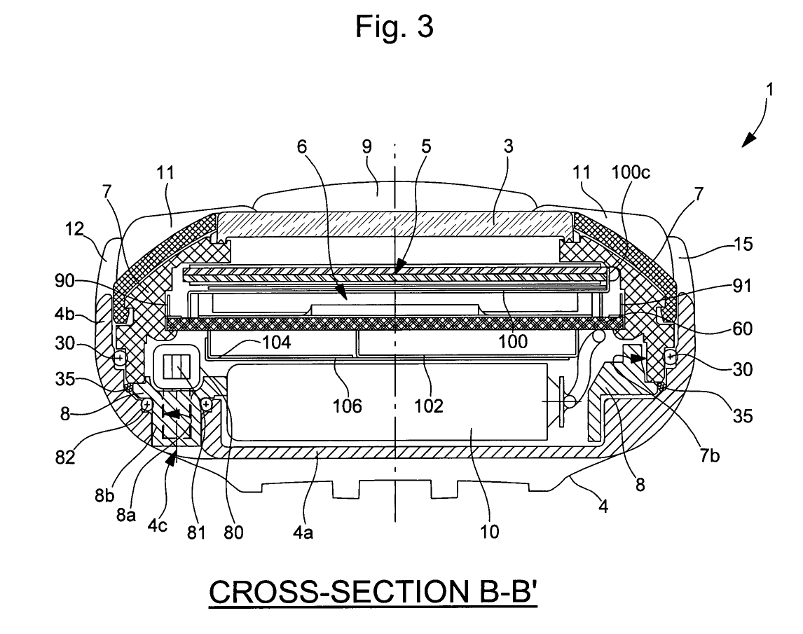

FIG. 3 is a cross-section of the wristwatch taken along the cross-section line B-B′ of FIG. 1;

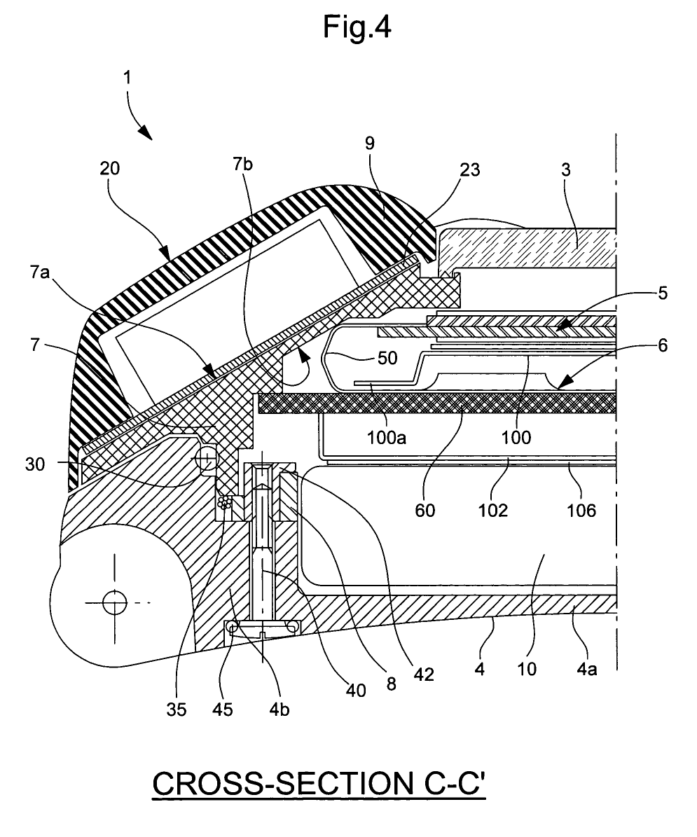

FIG. 4 is a partial cross-section of the wristwatch taken along the cross-section line C-C′ of FIG. 1;

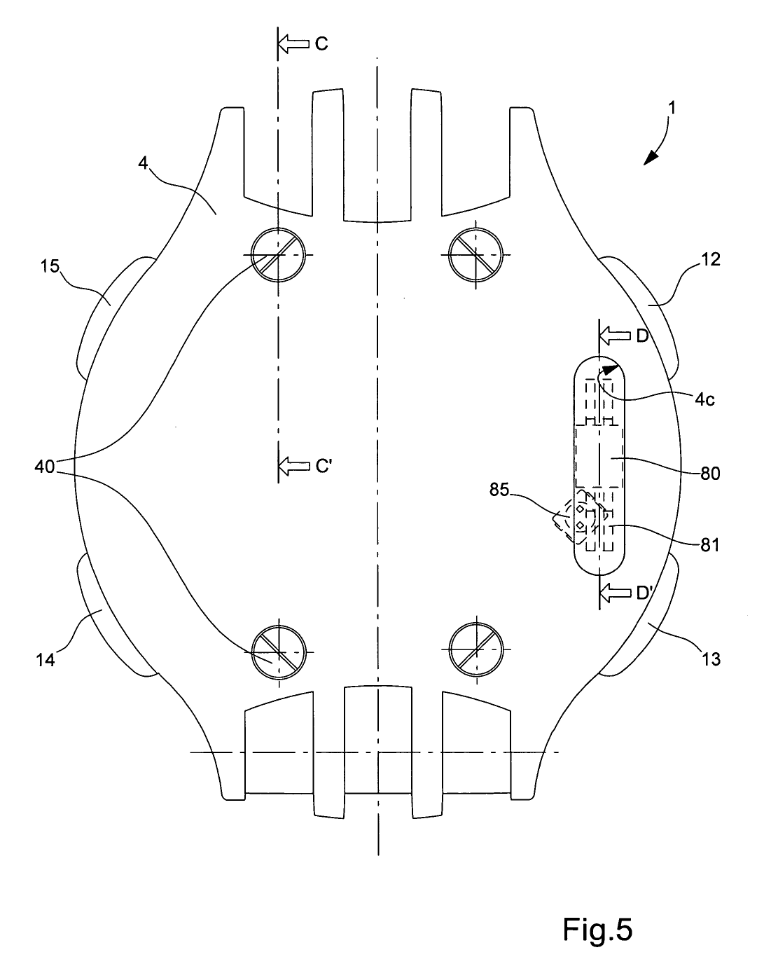

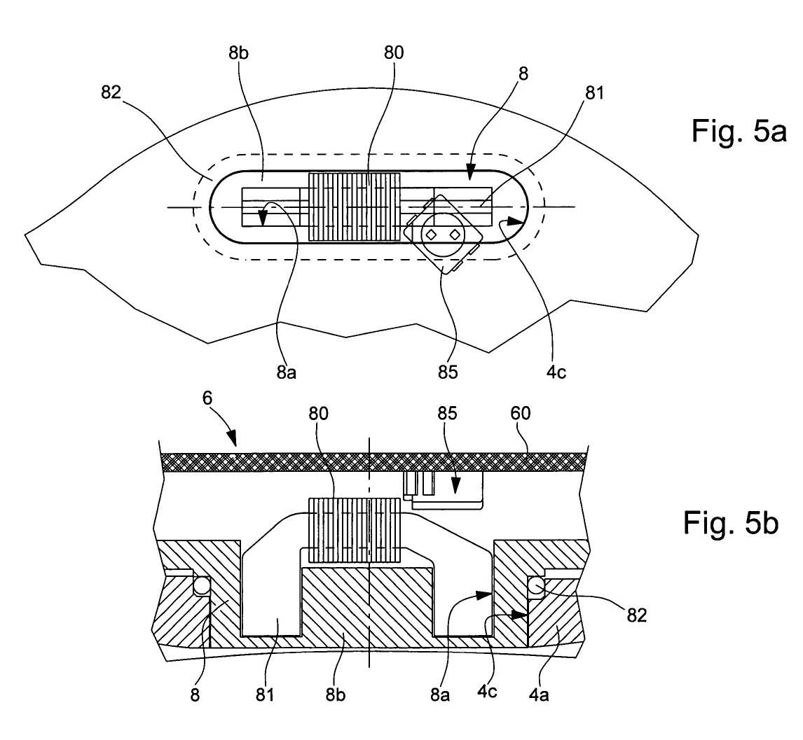

FIG. 5 is a plan view of the back of the wristwatch of FIG. 1;

FIGS. 5a and 5b are respectively a partial enlarged plan view of the back of the wristwatch and a partial cross-section taken along the cross-section line D-D′ of FIG. 5 showing the arrangement of an infrared transmission element and an inductive charge coil in the wristwatch according to the invention;

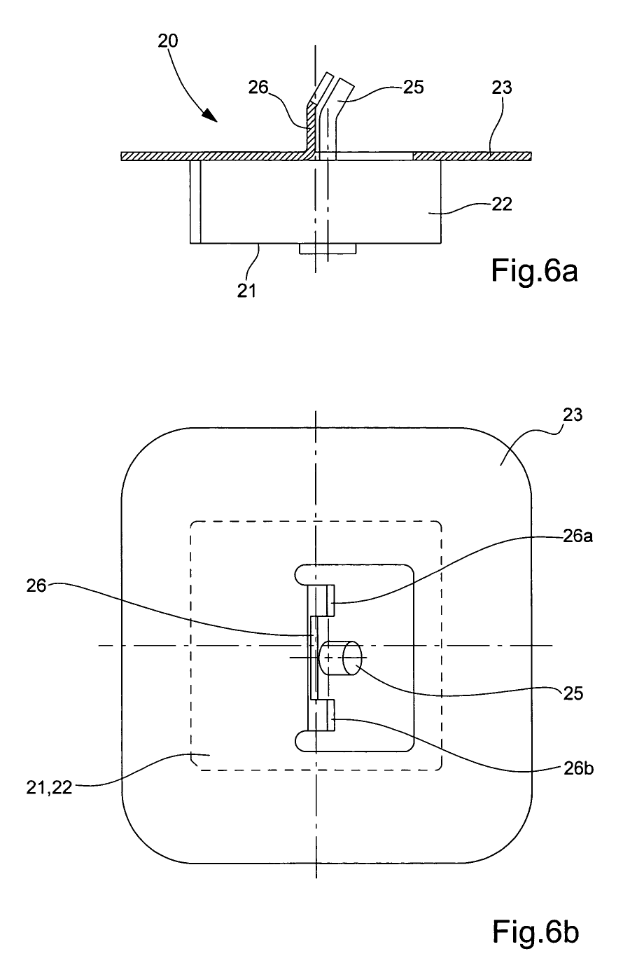

FIGS. 6a and 6b are respectively cross-section and plan views of a patch type antenna fitted to the wristwatch of FIG. 1;

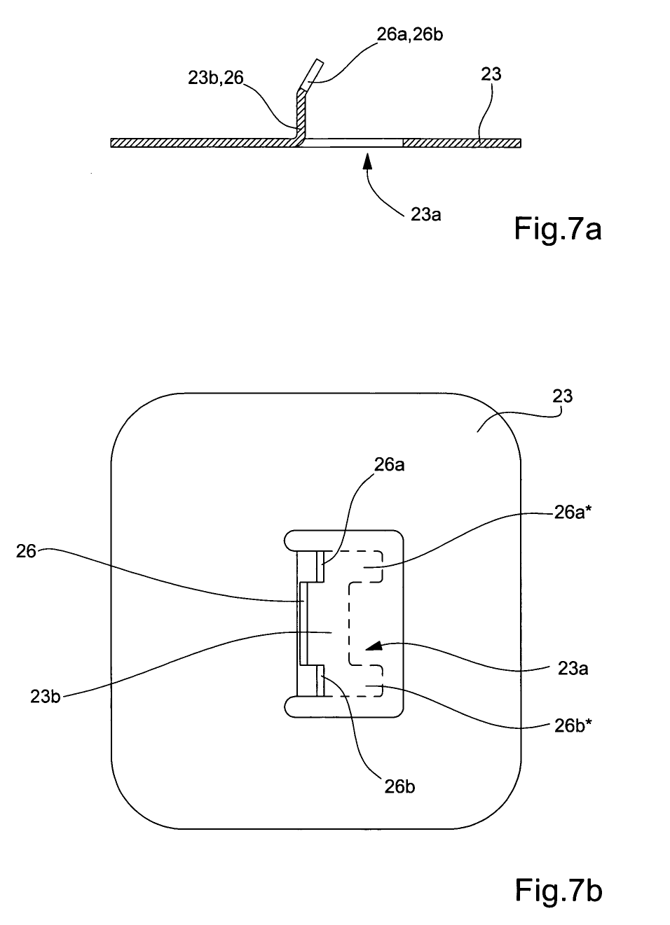

FIGS. 7a and 7b are respectively cross-section and plan views of the ground plane of the antenna illustrated in FIGS. 6a and 6b;

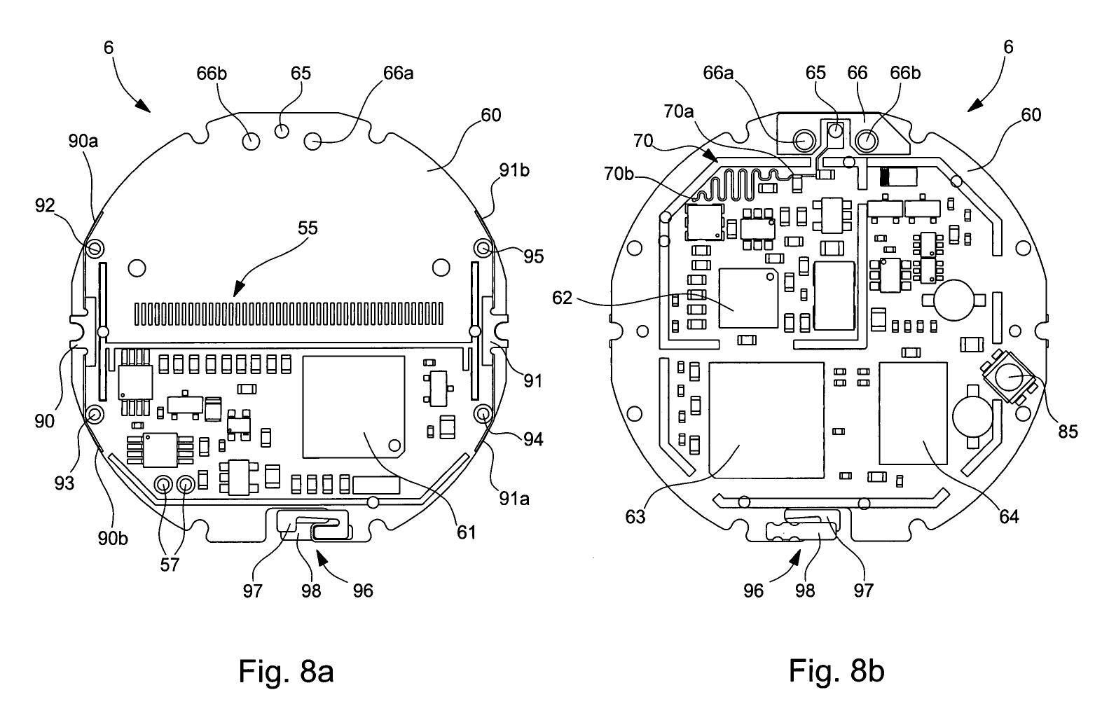

FIGS. 8a and 8b are plan views respectively from the crystal side and from the back cover side, of the electronic module of the wristwatch;

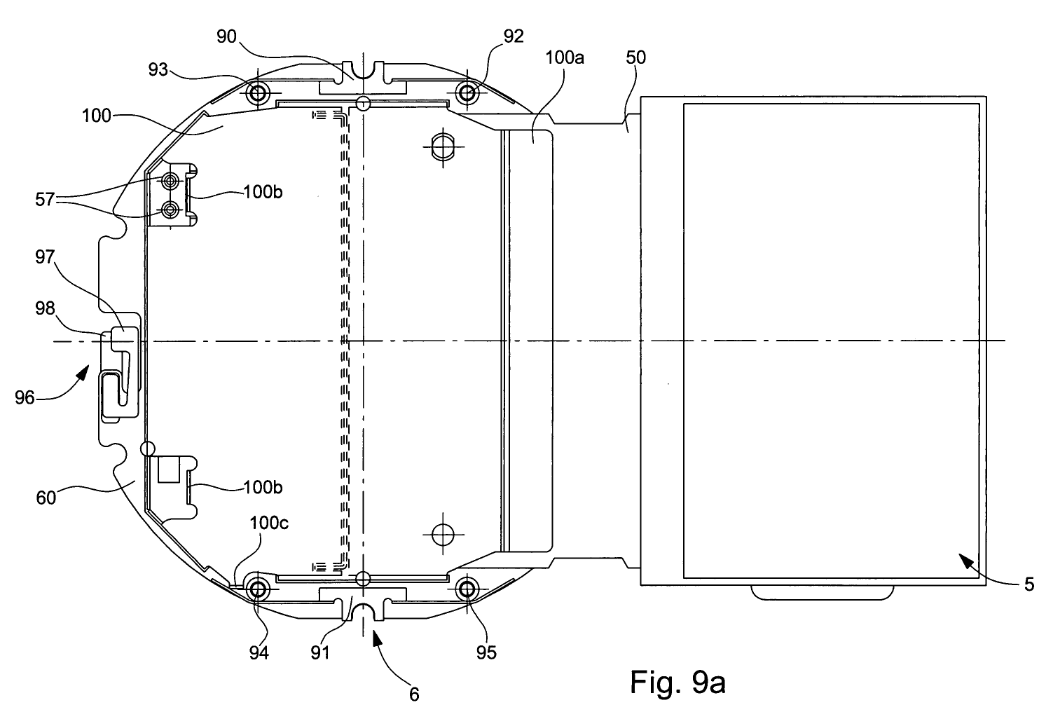

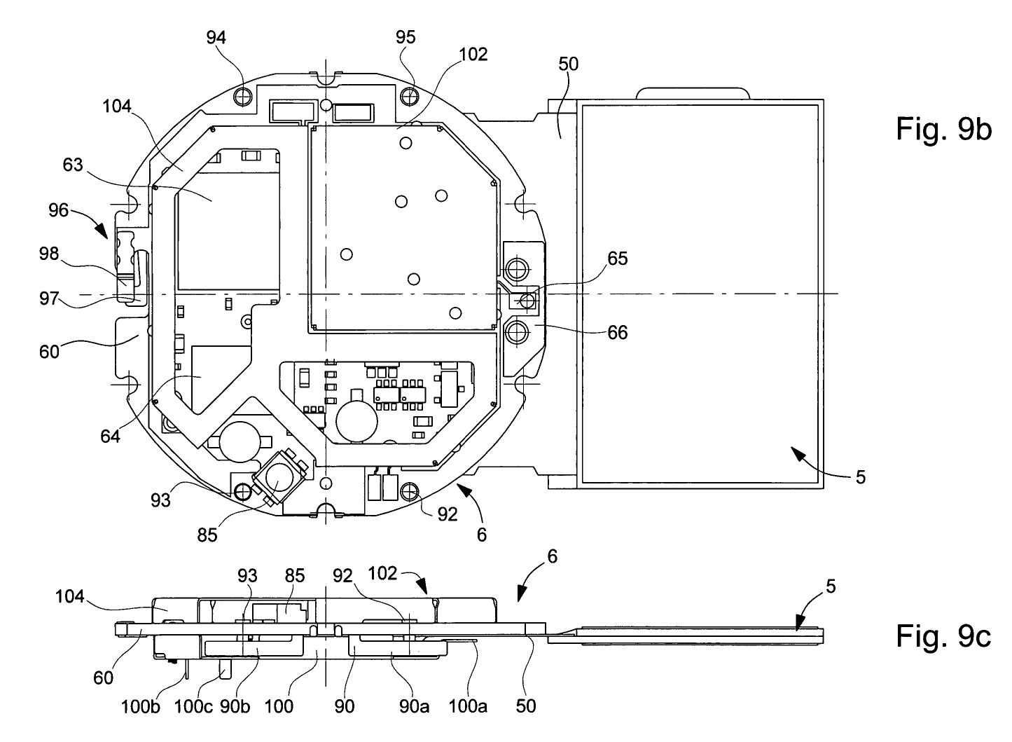

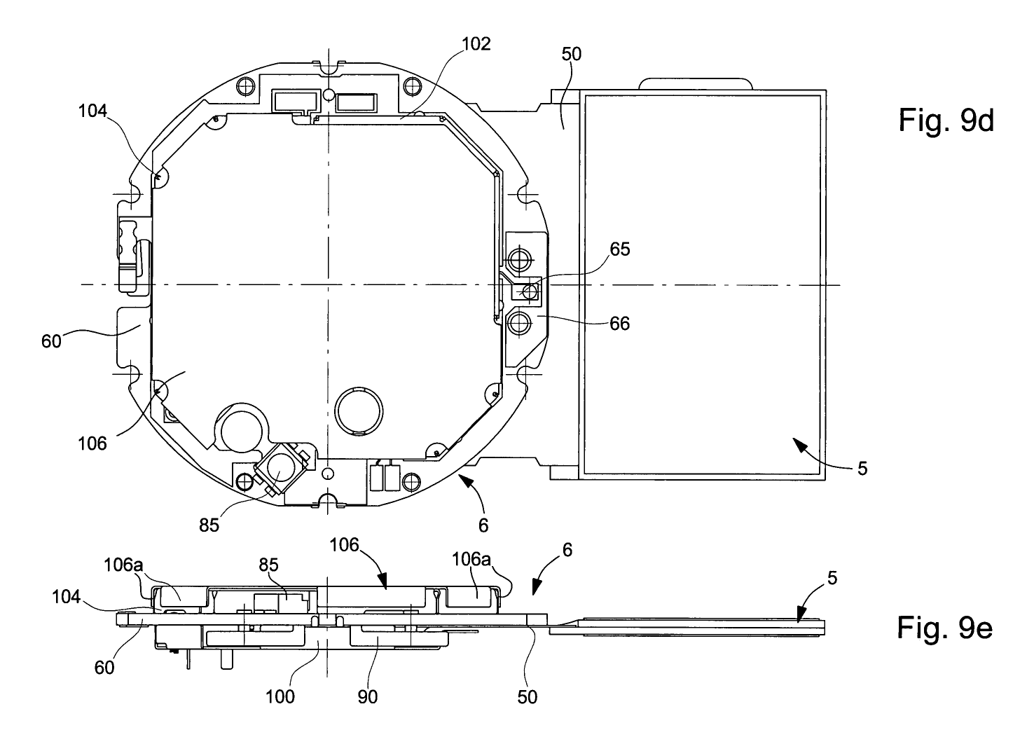

FIG. 9a is a plan view from the electronic module and the display device of the wristwatch showing, in particular, the shielding of the electronic module from the crystal side;

FIG. 9b is a plan view, from the back cover side, of the electronic module and the display device of the wristwatch showing a part of the shielding of the electronic module from the back cover side;

FIG. 9c is a lateral view of the electronic module of the display device illustrated in FIGS. 9a and 9b;

FIG. 9d is a plan view, from the back cover side, of the electronic module and the display device of the wristwatch showing the electronic module shielding assembly from the back cover side; and

FIG. 9e is a lateral view of the electronic module and the display device illustrated in FIG. 9d.

FIG. 1 shows a plan view of a portable electronic instrument according to the invention globally indicated by the reference numeral 1 and advantageously taking the form of a wristwatch. This wristwatch 1 is fitted with an antenna 20 electrically connected to an electronic module (6 in FIG. 2) arranged inside the wristwatch. In this example, this antenna 20 is intended to allow reception of radio-frequency signals transmitted by one or more distant transmission sources. More particularly, this antenna is intended to allow reception of satellite positioning and navigation signals, such as GPS signals (Global Positioning System) originating from the American system NAVSTAR or other similar satellite positioning signals such as the Russian system GLONASS or the future European satellite positioning system GALILEO.

By extension, the present invention is also applicable to any type of portable electronic instrument including an antenna for receiving and/or transmitting radio-frequency signals and is thus not limited to the single application of GPS signal receiver.

Wristwatch 1 has a similar general appearance to a conventional wristwatch and includes, in addition to antenna 20, a case globally designated by the reference numeral 2, a wristband (not shown) attached to case 2, a crystal 3 under which there is arranged a display device 5 enclosed in case 2 (such as a liquid crystal display) and control members 12 to 16, namely five push-buttons, one (16) placed at 6 o'clock and the other four (12 to 15) on the periphery of case 2.

FIG. 2 shows a cross-section of the wristwatch 1 illustrated in FIG. 1 taken along the cross-section line A-A′ parallel to the 6 o'clock-12 o'clock axis and passing through the centre of the wristwatch. One can see case 2, crystal 3, display device 5, antenna 20 and push-button 16 placed at 6 o'clock. Wristwatch 1 further includes, arranged inside case 2, an electronic module 6 including, in particular, a printed circuit 60, on which are mounted the various electronic and electric components of the instrument, as well as an electric power source 10 powering, in particular, electronic module 6 and display device 5. In this example, power source 10 is formed of a rechargeable accumulator arranged in the back cover or bottom of case 2. This power source 10 could however be formed of a conventional battery (in which case a battery compartment would have to be provided preferably in the back cover of the case in order to allow it to be replaced) or any other source capable of providing a suitable electric power supply.

As illustrated in FIG. 2, display device 5, namely a liquid crystal display, is superposed on electric module 6 and rests on an upper face of electronic module 6. Display device 5 is electrically connected to electronic module 6 by a flexible connector 50. An electro-luminescent film designated by reference numeral 56 is inserted between display device 5 and electronic module 6. This electro-luminescent film 56 is electrically connected to electronic module 6 by a pair of connectors designated 57, only one of them being illustrated by way of explanation in FIG. 2. Each of these connectors 57 comprises a stud and a contact spring.

In FIG. 2, it will be noted that the reference numerals 100, 102, 104 and 106 indicated metal plates assuring shielding of the electronic circuit of module 6. FIGS. 9a to 9e which will be discussed hereinafter show the configuration of this shielding in more detail.

In the example illustrated, the rechargeable accumulator is recharged by means of an inductive charge system well known to those skilled in the art. Thus, wristwatch 1 is fitted with a coil intended to be coupled to an external coil of the inductive charge device. The arrangement of this inductive charge coil will be presented hereinafter with reference to FIGS. 3, 5, 5a and 5b.

According to the invention, case 2 includes an exterior body 4 with a bottom 4a or back cover and lateral walls 4b, as well as a bezel element 7 fitted onto exterior body 4. Bottom 4a and lateral walls 4b are preferably made in a single part, although one could envisage providing two distinct parts assembled to each other, and they together form, in this example, a back cover—middle part piece of wristwatch 1 to which the wristband (not shown) is typically attached.

Bezel element 7 is fitted onto exterior body 4, or more exactly onto the lateral walls 4b of exterior body 4, and supports crystal 3, the latter being preferably welded or bonded onto element 7. Advantageously, this bezel element 7 is made of plastic material, and crystal 3 is for example welded by a known ultrasound method.

Bezel element 7 is preferably fitted in a sealed manner onto the exterior body, for example via an O-ring joint 30 placed between a shoulder arranged on the periphery of element 7 and a similar shoulder arranged on lateral walls 4b of exterior body 4.

According to the invention, antenna 20 is mechanically supported by bezel element 7 and rests on an outer face, designated 7a, of this element. This antenna 20 may, if required, be bonded onto outer face 7a or held by other suitable fixing means. Antenna 20 is advantageously arranged at 12 o'clock and in an inclined position with respect to the plane, designated H, in which display device 5 is located. Consequently, the antenna is advantageously oriented substantially upwards in order to optimise reception of the GPS signals for the natural position of the wrist when the user reads data on display device 5. In addition to antenna 20, it will be noted that element 7 also supports control members 12 to 16 of the wristwatch.

Preferably, wristwatch 1 further includes an additional element 8 forming a casing ring arranged in case 2 between bezel element 7 and bottom 4a of exterior body 4. Elements 7 and 8 in a sense form the upper and lower parts of a container inside which display device 5 and electronic module 6 are enclosed. Power source 10 is arranged between casing ring element 8 and bottom 4a of exterior body 4. It will easily be understood that this accumulator could alternatively be enclosed between elements 7 and 8 with display device 5 and electronic module 6.

Preferably, elements 7 and 8 are secured to each other (for example by bonding, welding, snap fitting or any other similar securing means) so as to form a sub-assembly including, in particular, antenna 20, crystal 3, display device 5, electronic module 6 and control members 12 to 16 (see power source 10 as already mentioned). Consequently, this sub-assembly can be assembled separately and tested before being mounted in the bottom 4a of the exterior body. Conversely, this sub-assembly can easily be dismantled from the outer body to be replaced if necessary.

This advantageous construction also offers great flexibility as regards the exterior parts, exterior body 4 being able, for example, to be made of metal material without this compromising the functioning of the antenna.

FIGS. 3 and 4 illustrate other additional features of the preferred embodiment of the present invention. FIG. 3 is a cross-section of wristwatch 1 taken along the cross-section line B-B′ shown in FIG. 1 parallel to the 9 o'clock-3 o'clock axis of the watch and passing through its centre. FIG. 4 is a partial cross-section of wristwatch 1 taken along the cross-section line C-C′ of FIG. 1 parallel to the 6 o'clock-12 o'clock axis of the watch in an off-centre position.

FIG. 4 illustrates, in particular, securing means enabling the aforementioned sub-assembly to be secured to bottom 4a of exterior body 4. In this case, these securing means include four screws 40 (only one of these being shown in FIG. 4) penetrating element 8 through an orifice arranged in bottom 4a of the exterior body in accordance with the illustration of FIG. 5 which shows a back view of wristwatch 1. Each screw 40 co-operates with a clamping element 42 holding element 8 pressed against bottom 4a. Screws 40 are also each provided with an O-ring joint 45 arranged between the head of the screw and bottom 4a of the exterior body in order also to ensure that the assembly is sealed at this point.

Preferably, outer body 4 is made of a metal material and bezel element 7 (and element 8) is made of plastic material. An exterior covering element, designated by the reference numeral 11, of essentially annular shape, is also fitted onto element 7, here by snap-fitting as illustrated in the cross-section of FIG. 3, in order to cover this element 7. In this example, annular exterior element 11 is preferably made in a similar metal material to the material used to make exterior body 4 and has an aperture 11a (indicated in FIG. 1) in which antenna 20 is housed. A protective cap 9 made of dielectric material is also added to bezel element 7 in order to protect antenna 20 from the external environment. Alternatively, it will easily be understood that annular exterior element 11 and protective cap 9 could be made in a single part and of a material which does not disturb the operation of antenna 20.

FIG. 3 also partially shows the arrangement of the inductive charge coil, indicated by the reference numeral 80, allowing rechargeable accumulator 10 to be recharged. This charge coil 80 is wound around a ferromagnetic core 81 formed by a stack of sheet metal of small thickness. As illustrated in FIGS. 5a and 5b, this core 81 is arranged in a housing 8a made in casing ring element 8, the latter having a portion 8b extending into an aperture 4c made in bottom 4a of the exterior body. More specifically, ferromagnetic core 81 is generally U-shaped opening towards bottom 4a into aperture 4c, which is provided for this purpose. It will be noted that the essential role of ferromagnetic core 81 is to concentrate the flux and direct it towards the exterior of case 2 so as to assure suitable inductive coupling with an external coil of the inductive charge device (not shown).

As previously, an O-ring joint 82 is also arranged between a shoulder arranged on element 8 and a similar shoulder arranged on bottom 4a of the exterior body in order to assure sealing of the assembly at aperture 4c.

In addition to inductive charge coil 80 and its ferromagnetic coil 81, wristwatch 1 further includes a bidirectional infrared transmission element, designated 85, directed towards aperture 4c made in bottom 4a of the exterior body and enabling two-directional communication to be established with a peripheral external communication unit, which is advantageously connected to a computer terminal. This bidirectional infrared transmission element 85 typically includes an infrared emission diode for transmitting data from the watch and an infrared reception phototransistor (or alternatively a photodiode) for receiving data from the exterior. This element thus forms communication means allowing data to be exchanged, such as positioning data, with a computer terminal.

More specifically, as illustrated in FIGS. 5a and 5b, infrared transmission element 85 is arranged on the lower face of electronic module 6 and is oriented such that the infrared beam can pass, without obstacle, through portion 8b of casing ring element 8 which extends into aperture 4c. In this case, the material used to make element 8, or at least to make portion 8b, absolutely must be transparent to the infrared light. It will of course be understood that infrared transmission element 85 could alternatively be arranged in a separate housing and/or in a closer position to bottom 4a of the exterior body.

In the event that exterior body 4 and bezel element 7 are respectively made of metal and plastic materials, it will be advantageous to metallise the inner walls of element 7, designated by the reference numeral 7b in FIGS. 2 to 4, and to connect this metallisation electrically to metal exterior body 4. Such metallisation would have the advantage of further improving the shielding of the electronic components arranged inside the wristwatch. In order to assure optimum connection between a metallisation of inner walls 7b of element 7 and metal exterior body 4, it will be advantageous also to provide a conductor, for example made of metal material, between element 7 and exterior body 4. FIGS. 2, 3 and 4 show such a conductor, designated by the reference numeral 35, arranged at the junction between elements 7 and 8 on exterior body 4.

With reference again more particularly to FIG. 2, it can be seen that antenna 20 is a patch type antenna, i.e. an antenna of essentially parallelepiped shape including a radiating element 21 separated from an ground plane 23 of greater dimension by a dielectric 22, like a ceramic element. Radiating element 21 is fed by a feed or excitation conductor 25 insulated from ground plane 23 and passing through dielectric 22 to be connected to electronic module 6, element 7 being provided with an aperture 7c allowing the passage of feed conductor 25. Ground plane 23 is electrically connected to the electronic module by a separate ground conductor 26, which also passes through aperture 7c. Patch type antennae are commonly used and have the advantage of simple construction and low manufacturing costs.

According to the invention, antenna 20 thus rests on outer face 7a of bezel element 7 via its ground plane 23. In solutions of the prior art, this type of antenna is generally arranged directly on the surface of the electronic module, this having the aforementioned drawbacks, namely greater interference with the electronic circuits of the watch requiring specific shielding and the impossibility of making the case in a metal material. It will be noted that ground plane 23 of antenna 20 will preferably be bonded to outer face 7a of bezel element 7.

Reference will now be made to FIGS. 6a, 6b, 7a and 7b, which illustrate in more detail the particular structure of patch antenna, 20 and, particularly, its ground plane 23. FIGS. 6a and 6b thus respectively show a cross-section and a plan view of patch antenna 20 used within the scope of the preferred embodiment of the invention. One can see radiating element 21, dielectric 22 and ground plane 23, as well as feed and ground conductors 25 and 26.

As illustrated in FIG. 6b, feed conductor 25 is off-centre with respect to the centre of symmetry of radiating element 21, so that antenna 20 has circular type polarisation. The distance separating feed conductor 25 from ground conductor 26 is also selected in a conventional manner to adapt the antenna properly to the associated reception circuit.

More particular, according to the invention, ground plane 23 includes two legs 26a and 26b extending outside ground plane 23 and forming ground conductor 26. FIGS. 7a and 7b show the structure of ground plane 23 in more detail. This ground plane 23 is advantageously made from a metal plate formed by a conventional stamping method. This plate is initially cut such that it has a central aperture 23a into which an essentially U-shaped extension 23b projects, opening into centre aperture 23a and from which legs 26a, 26b are finally formed. The structure of ground plane 23, at the end of the cutting operation, is illustrated in dotted lines in FIG. 7b, the legs being designated at this stage by the reference numerals 26a* and 26b*. Extension 23b is subsequently bent so that legs 26a, 26b thereby formed, extend outside ground plane 23 as illustrated. It will be noted that feed conductor 25 is formed so as to have a similar profile as illustrated in FIGS. 6a and 6b.

Consequently, ground conductor 26 forms an integral part of ground plane 23, thus greatly simplifying the connection of antenna 20 to electronic module 6, although this antenna 20 does not rest directly on electronic module 6.

FIGS. 8a and 8b are plan views, respectively from the crystal side and from the back cover side, of electronic module 6 to which antenna 20 is connected. Printed circuit 60 of the electronic module carries, on each of its faces, the electric and electronic components assuring the various functions of the instrument. As illustrated schematically in FIG. 8a, printed circuit 60 carries, in particular, on the crystal side, a clock type integrated circuit 61 assuring the conventional clock functions of the watch, as well as other components such as a quartz resonator and its division chain (not shown). As illustrated in FIG. 8a, a plurality of connecting terminals 55 intended to be connected to display device 5 are also arranged on printed circuit 60 on the crystal side. The aforementioned pair of connectors 57 of electro-luminescent film 56 is also connected on this face of electronic module 6.

The crystal side face of printed circuit 60 further includes two contact elements designated 90 and 91 for co-operating with push-buttons 12 to 15 arranged on the periphery of the wristwatch. Each contact element 90, 91 has a pair of resilient tongues 90a, 90b and 91a, 91b capable, via the action of each push-button 12 to 15, of coming into contact with contact studs 92 to 95 arranged on printed circuit 60 and connected to terminals of integrated clock circuit 61.

The crystal side face of the printed circuit also includes a first contact tongue 97 of a contact 96 associated with push-button 16 placed at 6 o'clock. This first tongue strip 97 co-operates with a second contact tongue 98 placed on the opposite face of printed circuit 60 as illustrated in FIG. 8b. This contact 96 is also illustrated in cross-section in FIG. 2.

As illustrated schematically in FIG. 8b, printed circuit 60 carries on the back cover side, a radio-frequency signal reception or RF circuit 62, a microprocessor 63 responsible for extracting positioning and navigation data contained in the radio-frequency signals from satellites and an EEPROM memory or FLASH memory 64 allowing, in particular, storage of certain parameters necessary for acquiring the satellites (such as the pseudo-random codes of the various satellites). The aforementioned infrared transmission element 85 is also found on this face of electronic module 6.

One will not dwell here on the particular embodiment of the electronic circuit for extracting positioning and navigation data. Those skilled in the art could for example refer to the vast technical literature relating to the GPS components available on the market.

FIGS. 8a and 8b also show a feed point, designated 65, to which feed conductor 35 of antenna 20 is connected, as well as a ground point 66 to which ground plane 23 of the antenna 20 is connected. More particularly, ground point 66 includes two contact orifices 66a and 66b for receiving the two legs 26a and 26b of the ground plane of antenna 20.

According to the present invention, there are further provided protection means for protecting antenna 20 and the circuits associated therewith (RF electronic part, input amplifier circuit, etc.) against electrostatic discharge. These protection means advantageously include, made on electronic module 6 on the back cover side as illustrated in FIG. 8b, a printed serpentine path designated 70, forming a resonant circuit electrically connected via its ends 70a and 70b to feed and ground conductors 25 and 26 of the antenna. The first end 70a of printed serpentine 70 is thus connected to antenna feed point 65 and the other end 70b is electrically connected to ground point 66 (this connection is not visible in FIG. 8b).

With reference to FIGS. 9a to 9e, the structure utilised to shield the various electronic components of module 6 will now be described. FIG. 9a thus shows electronic module 6 on the crystal side as well as display device 5, which is connected to electronic module 6 via flexible connector 50, connected to the connection terminals 55 arranged on printed circuit 60 on the crystal side. As illustrated in FIG. 2, this flexible connector 50 allows display device 5 to be arranged, after bending, on the upper face of electronic module 6 once the latter are mounted in wristwatch 1.

The shielding of the components on the crystal side, namely, in particular, clock microprocessor 61, is made by means of a first metal stamped plate 100 secured (for example by welding) to printed circuit 60 and substantially covering the entire surface of printed circuit 60. This first metal plate 100 further includes an edge 100a bend towards the surface of printed circuit 60 and forming a slot-shaped aperture, which is as narrow as possible, through which flexible connector 50 of display device 5 passes. The purpose of this narrow slot is to improve the shielding effect and produce a maximum capacitive coupling effect against the ground of the signals coming from electronic module 6 to display device 5, which contributes to greatly reducing the transmission of electromagnetic interference from electronic module 67 to the exterior of the shielding.

Portions 100b and 100c of first metal sheet 100 are also bent in the direction of the crystal to act, in particular, as a support and positioning stop for display device 5 when the latter is bent over electronic module 6. It will be noted that the pair of connectors 57 of the electro-luminescent film (not shown in this Figure) passes through metal sheet 100 through an aperture arranged in proximity to one of the portions 100b.

The shielding of the components on the back cover side, namely, in particular, RF circuit 62, microprocessor 63 and FLASH memory 64, is made by means of three other stamped metal plates designated 102, 104 and 106. FIG. 9b shows a part of the shielding on the back cover side. RF circuit 62 is thus covered by a second stamped metal plate 102, secured to printed circuit 60. A third stamped metal plate or frame 104, also secured to printed circuit 60, covers microprocessor 63 responsible for extracting positioning and navigation data as well as FLASH memory 64. This third stamped metal plate 104 and second plate 102 act as a support for a fourth stamped metal plate 106, illustrated in FIG. 9d, substantially covering the entire surface of printed circuit 60 on the back cover side and enabling the set of electronic components to be properly shielded. This fourth metal plate 106 rests on the second and third plates 102 and 104, ends 106a of the fourth plate 106 being bend over the periphery of plates 102 and 104. This fourth metal plate 106 is arranged accordingly so as to be able to be easily removed if required in order to access the electronic components located below as well as the test terminals (not shown) arranged on this face of printed circuit 60.

It will be understood that numerous modifications could be made to the shielding structure which has just been described. The description of the shielding of the components should thus not be considered in any way as a limitation of the scope of the invention.

It will be understood generally that various modifications and/or improvements obvious to those skilled in the art can be made to the embodiment described in the present description without departing from the scope of the invention defined by the annexed claims. In particular, the present invention is not limited to a wristwatch or to a portable instrument including a patch type antenna. This patch antenna nonetheless constitutes an antenna example perfectly suited to receiving satellite positioning and navigation signals and the construction of which is very simple and inexpensive.

It will also be understood that the use of casing ring element 8 is not strictly necessary and that the choice of materials used to make the various exterior and construction elements is given solely by way of example.

1. Portable electronic instrument, such as a wristwatch (1), including:
a case (2) enclosing an electronic module (6) and a display device (5);
a crystal (3) fitted onto said case (2);
an electric power supply source (10) housed in said case (2) and powering said electronic module (6) and said display device (5); and
an antenna (20) for receiving and/or transmitting radio-frequency signals electrically connected to said electronic module (6),
characterised in that said case (2) includes:
an exterior body (4) including a bottom (4a) and lateral walls (4b); and
a bezel element (7) fitted onto said exterior body (4) and supporting said crystal (3), and in that said antenna (20) rests on an outer face (7a) of said bezel element (7).

2. Instrument according to claim 1, characterised in that said bezel element (7) is fitted in a sealed manner onto said exterior body (4).

3. Instrument according to claim 1 or 2, further including a casing ring element (8) arranged between said bezel element (7) and said bottom (4a), said electronic module (6) and said display device (5) being enclosed between said bezel element (7) and said casing ring element (8).

4. Instrument according to claim 3, characterised in that said casing ring element (8) and said bezel element (7) are secured to each other so as to form a sub-assembly able to be mounted on and dismantled from said exterior body (4).

5. Instrument according to claim 3 or 4, characterised in that said casing ring element (8) is held in said bottom (4a) by fixing means (40, 42).

6. Instrument according to any of the preceding claims, characterised in that said exterior body (4) is made of metal material and in that said bezel element (7) is made of plastic material.

7. Instrument according to claim 6, characterised in that an inner face (7b) of said bezel element (7) is metallised and electrically connected to said exterior body (4) made of metal material.

8. Instrument according to claim 6 or 7, further including an exterior element (11) made of metal material of essentially annular shape fitted onto said bezel element (7), this annular-shaped exterior element having an aperture (11a) inside which said antenna (20) is housed.

9. Instrument according to any of the preceding claims, further including a protective cover (9) made of dielectric material fitted onto said bezel element (7) and covering said antenna (20).

10. Instrument according to any of the preceding claims, characterised in that said antenna (20) is a patch type antenna including a radiating element (21) separated from a ground plane (23) by a dielectric (22) and electrically connected to said electronic module (6) by a feed conductor (25), said ground plane (23) resting on the outer face (7a) of said bezel element (7) and being electrically connected to said electronic module (6) by ground conductor (26).

11. Instrument according to claim 10, characterised in that said ground plane (23) is formed of stamped metal plate including at least one leg (26a, 26b) bent outside the ground plane and directly connecting said ground plane (23) to said electronic module (6), said leg (26a, 26b) forming said antenna ground conductor (26).

12. Instrument according to claim 10 or 11, characterised in that said antenna (20) is arranged at 12 o'clock with respect to said display device (5) and in an inclined position with respect to the plane (11) in which said display device (5) is located.

13. Instrument according to claims 10 to 12, characterised in that said electronic module (6) includes a printed circuit board (60) to which said antenna (20) is connected,
and wherein said instrument further includes protection means (70) for protecting said antenna (20) and the circuits associated with said antenna (20) against electrostatic discharge, these protection means including a printed serpentine path (70) electrically connected via its ends (70a, 70b) between said excitation (25) and ground (26) conductors of the antenna.

14. Instrument according to any of the preceding claims, characterised in that said bottom (4a) and said lateral walls (4b) are made in a single part.
